(19) United States
(12) Patent Application Publication
(10) Pub. No.: US 2005/0172596 A1
(43) Pub. Date: Aug. 11, 2005

(54) Steep slope grass cutter

(76) Inventor: Earl Monroe White, Locust Grove, GA (US)

Correspondence Address: EARL MONROE WHITE, 150 LEGUIN MILL ROAD, P.O. BOX 15, LOCUST GROVE, GA, 30248, US

(21) Appl. No.: 10/924,561

(22) Filed: Aug. 24, 2004

Related U.S. Application Data
(60) Provisional application No. 60/542,946, filed on Feb. 9, 2004.

(51) Int. Cl. A01D 34/43

(52) U.S. Cl. 56/14.7

(57) ABSTRACT

The new art to which this application pertains is an electrically operated boom, of various overall lengths, to extend a small rotary blade electric grass cutter from a nominal 5 to 20 feet down, or out, to cut grass on steep slopes and in ditches. It is a fully mechanized electric grass cutting machine for cutting grass where it is difficult, impossible, or unsafe to stand up. It is an electric, rotary blade, grass cutting-head on the end of a three-section electrically powered telescoping boom, mounted on a powered carrier vehicle; such as, a small riding mower. The carrier vehicle is not a part of this application. It can be operated by persons of limited strength, physical abilities or aptitudes. It is controlled with two electric switches and one hand crank. Complete machine and carrier are inexpensive; less than the cost of a small riding mower. It is a machine for average people who are not skilled in machine operation; and for residential use.

### CROSS REFERENCE TO RELATED APPLICATION:

This application claims the benefit of Provisional Patent Application, U.S. application Ser. No. 60/542,946 Filing Date Feb. 9, 2004 Confirmation No. 8445, Title: Steep Slope Grass Cutter.

### FEDERALLY SPONSORED RESEARCH

Not applicable

### SEQUENCE LISTING OR PROGRAM

Not applicable

### BACKGROUND OF THE INVENTION—FIELD OF INVENTION

This invention relates to lawn or yard maintenance equipment and attachments; specifically, grass cutting machine attachments, residential/yard use; or, off-road use.

### BACKGROUND OF THE INVENTION

Residential grass and weed cutting of difficult areas is sometimes done with string trimmers, hand clippers and/or by hand-pulling the grass and weeds. These are places such as steep banks, ditches, around ponds or wet ground where mowers cannot be used. Gasoline powered riding and walk-behind mowers should never be used on steep slopes and ditches; but they are. Resulting in many terrible injuries every year. Use of this invention would eliminate these risks and injuries. This type grass cutting is dangerous or impossible in some places; especially for the weak or elderly, and then the work must be contracted to yard workers, or not done. There is no machine for this type work by ordinary, unskilled homeowners.

### BACKGROUND OF THE INVENTION—PRIOR ART

I am not aware of any prior art, nor any mechanized device, machine or mower attachment like this invention.

### BACKGROUND OF THE INVENTION—OBJECTS AND ADVANTAGES

The primary object of this invention is to provide an inexpensive, easy to operate, grass cutting attachment for riding mowers for cutting steep banks, ditches, and other hard places. It is a machine for average yard use, which average people can afford, can operate, and can maintain. The cost of this grass cutter, including an engine driven carrier vehicle, is less than the cost of a small riding lawn mower. The carrier vehicle is not shown in the detailed drawings because it, the carrier, is not part of this application. Other advantages of this invention are described later. It is a machine for grass and weed cutting of hard to reach, or impossible to reach, places as illustrated in FIG. 1. It cuts slopes as steep as 45 degrees; under decks and shrubbery, and areas where people cannot stand. This invention serves the aged and infirm especially because it requires the use of only one hand and one foot to operate. It is fully mechanized, and the operator simply rides, steers, and works electric switch controls, and one easy to operate hand crank wheel for elevation adjustment. This machine can operate with boom reaching downward or upward. It cuts as it travels and also as it is boomed out and in. The cutter can ride up the bottom or sides of a ditch and ride up and over low obstacles, such as driveway pipes, rock walls and similar low obstacles. Existing methods of cutting such places requires much strength and hard work; and, cranking, carrying and repairing such devices as clippers, string trimmers and other hand tools; even sometimes working down on hands and knees. This grass cutting attachment, and boom, operates from the power of a small, 20 amp-hour battery of the carrier vehicle. When cutting, it works best to unlock elevation 58 FIG. 2 and let it follow the lay of land, on the cutter-head's own four swiveled wheels 95 FIG. 4.

### SUMMARY

This mower attachment is a fully mechanized, wheeled, rotary blade, electric grass and weed cutter, on the end of a three-section, electrically telescoping boom. The boom is mounted on the hood of a carrier vehicle, such as a small riding lawnmower, or other steerable vehicle. Its simplicity makes maintenance easy. No welding was required, or used, to make the model herein described. Total weight is 68 pounds; but removable wheeled carriage 40 FIG. 2 allows a fairly able person to install and remove entire boom and cutter, if desired. It is preferable to leave it assembled. It is totally electric, uses no fuel; has no engine to start, except the carrier or mower it is mounted on. Carrier vehicle is starter-cranked by its battery. Carrier vehicle is a small riding mower chassis, and it is not part of this application.

### DRAWINGS—FIGURES

FIG. 1 is an overall sketch of this invention cutting grass and small weeds on a steep bank, of about 45 degrees slope, about 20 feet from top to bottom.

FIG. 2 is an isometric exploded view of boom section 1.

FIG. 3 is an isometric view of boom section 2.

FIG. 4 is an isometric view of boom section 3 showing where cutter mounts.

FIG. 5 is a side view of cutter-head and blade.

FIG. 6 is a diagram of boom and cutter electric wiring, and control box. One switch turns cutter on and off; another switch is a 3-position switch and extends boom out, retracts it, and center is off.

FIG. 7 shows details of how all support arms and cross arm braces are attached to boom tubes.

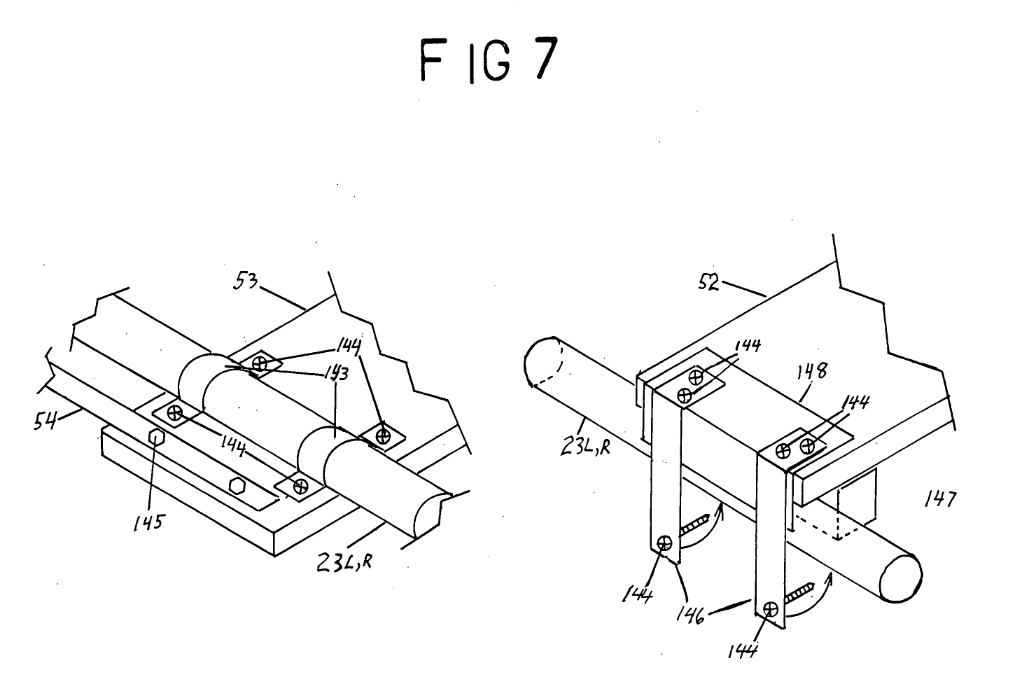

### DRAWINGS—REFERENCE NUMERALS

20 counter-weight box
20A straps, weight box
21 counter-weights
22 wire, weight retainers
23L tube, metal, boom section 1, left
23R tube, metal, boom section 1, right
24 pulley-reel, boom extend, 3½ inch diameter
25 pulley-reel, boom retract, 3½ inch diameter
26 pulley, V-belt, boom drive, driven pulley, 6 inch
27 pulley, V-belt, boom drive, drive pulley, 1½ inch
27A V-belt, boom drive
28 boom motor, gear-head, automotive windshield wiper type
29 wheel, idler, boom extend, spring loaded
30 spring, boom retract, rope tension
31 push rod, boom ½ inch diameter
32 rope, retract boom
33 rope, extend boom
34 pulley, boom rope
35 bushing plate, boom drive shaft, upper
36 bushing plate, boom drive shaft, lower
36A screw, wood, no. 6, flat head, ¾ inch, bushing plates
37 spring, idler
38 lever, idler mounting
39 roller guide, push rod
40 carriage, wheeled
41 screw, metal, pan, Phillips 34 inch
42 strap, metal, 2-hole
43 wheel, carriage, 7 inch
44 latch, carriage to box
45 screw, metal, pan Phillips, no. 8 1 inch
46 shoulder bolt, wood
47 pulley, elevation rope
48 snap fastener
49 shaft, elevation crank
50 rope, elevation, down
51 rope, elevation, up
52 brace, cross arm
53 support, boom, cross arm
54 bar, ¼ inch metal, boom support
55 bolt, ¼ by 2½ and locknuts
56 stud, shoulder ¼ inch
57 springs, leaf, boom centering
58 brake-lock, elevation shaft
59 crank, hand, elevation shaft
60 connector, electric, 4-wire, boom half
61 connector, electric, 4-wire, carrier vehicle half
62 support, boom, ½ inch pipe
63 mount, boom support
64 universal pipe joint, ½ inch
64A Floor Flange, ½ inch
65 bolt, ¼ by 3½
66 locknut, hex
67 washer
68 bolt, machine, ¼ by 2 inch
69 bolt, machine, ½ by 6 inch
70 electric wire, 2-wire no. 14, cutter motor
71 electric wire, 2-wire no. 14, boom motor
80 bolt, push rod connection
81 washer
82 thumb screw
83L tube, metal, boom 2^{nd} section left
83R tube, metal, boom 2^{nd} section right
90L tube, metal, boom, 3^{rd} section left
90R tube, metal, boom, 3^{rd} section right
91 connector, 2-wire, cutter motor, boom-half
92 motor support/mount, cutter
93 wheel support
94 arms, wheel mount
95 swivel, wheel
96 strap, metal, 2-hole
97 screw, metal, pan Phillips, ¾ inch
98 wheel, 5 inch
99 locknut, hex
100 flat washer
101 bolt, ¼ inch, washer/spacer/locknut
110 connector, electric, 2-wire, cutter motor, motor-half
111 cutter motor, 12 volt D.C., auto heater fan type
112 ground connection
113 jack-shaft
114 cover, jack-shaft/bearing
115 pin cotter
116 coupler, shaft, hex, metal
117 motor shaft
118 jack-shaft, 5/16 inch threaded
119 ball bearing
120 bearing clamp
121 bolt, 10-24
122 nut, 10-24
123 locknut
124 washer
127 compression washer
130 blade
131 sharpened, cutting edge
140 90-degree bend, down 90-degrees
141 30 degree bend, up 90 degree
142 30 degree forward, sythe shape
143 clamp, pipe, 1 inch
144 screw, metal, pen, Phillips, 1 inch
145 bolt, hex, ¼ inch by 2½ inch
146 strap, metal
147 strip, wood, ¾ by ¾ inch
148 joint connector, metal-stud
150 control box, switches, front view
151 wires to battery
152 switch, boom out-in, back view
153 switch, cutter motor, back view
154 soldered connections to boom wiring
155 fuse, inline, 25 amp, autmv type

### DETAILED DESCRIPTION

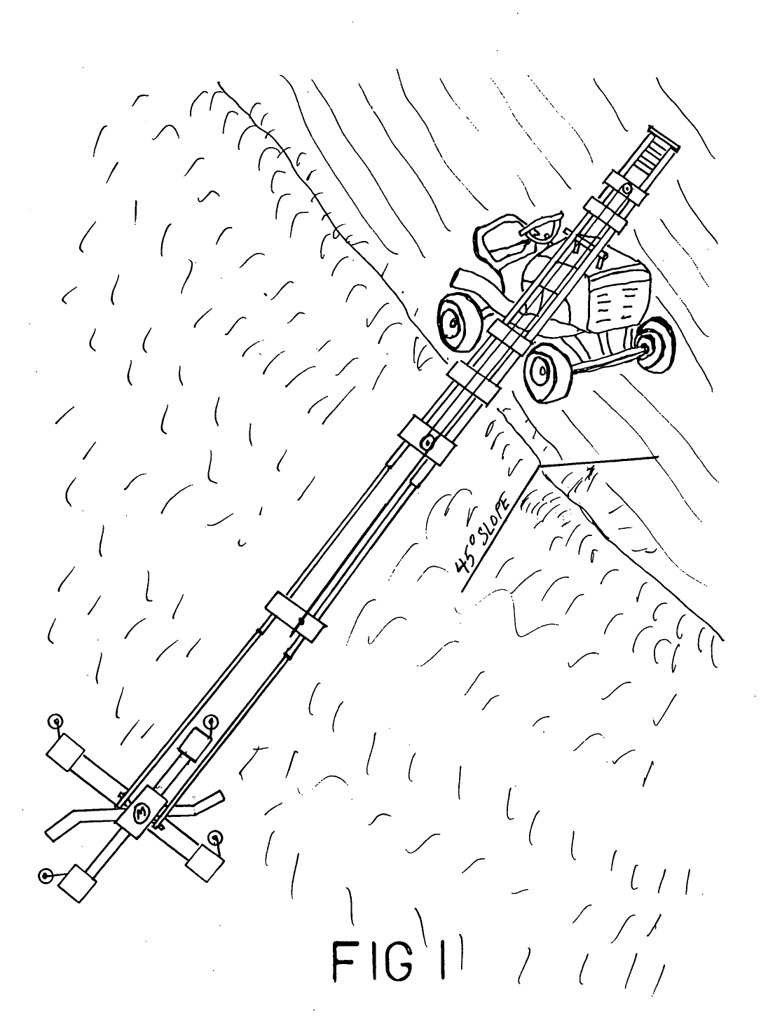

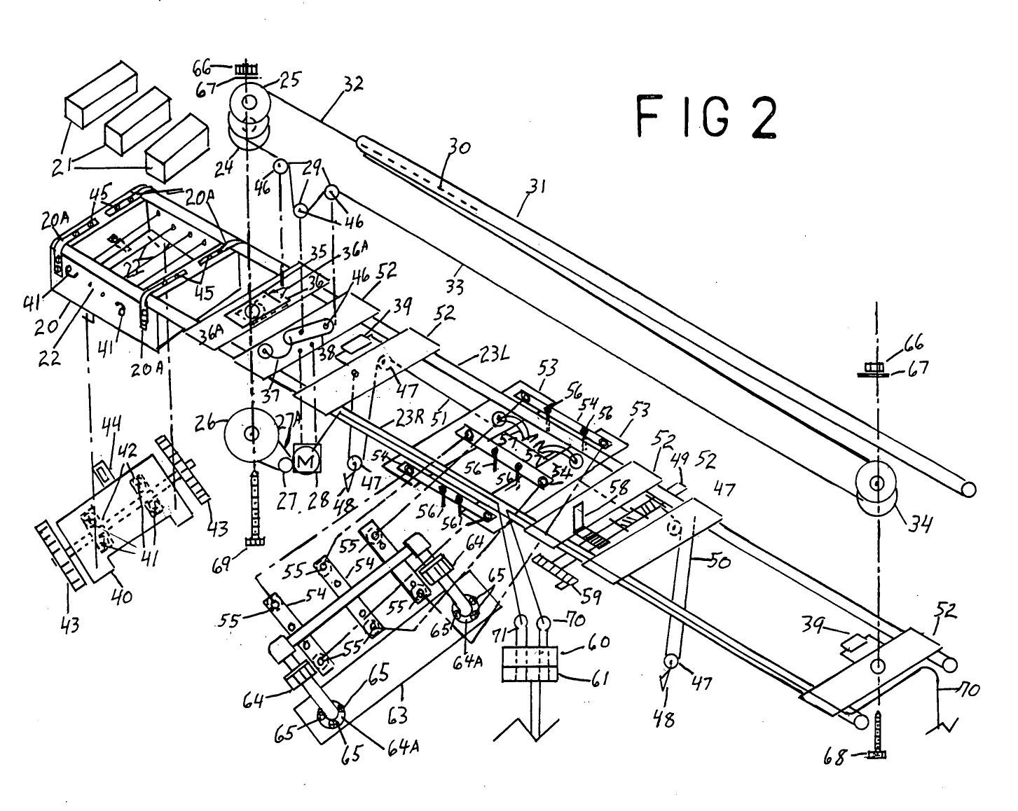

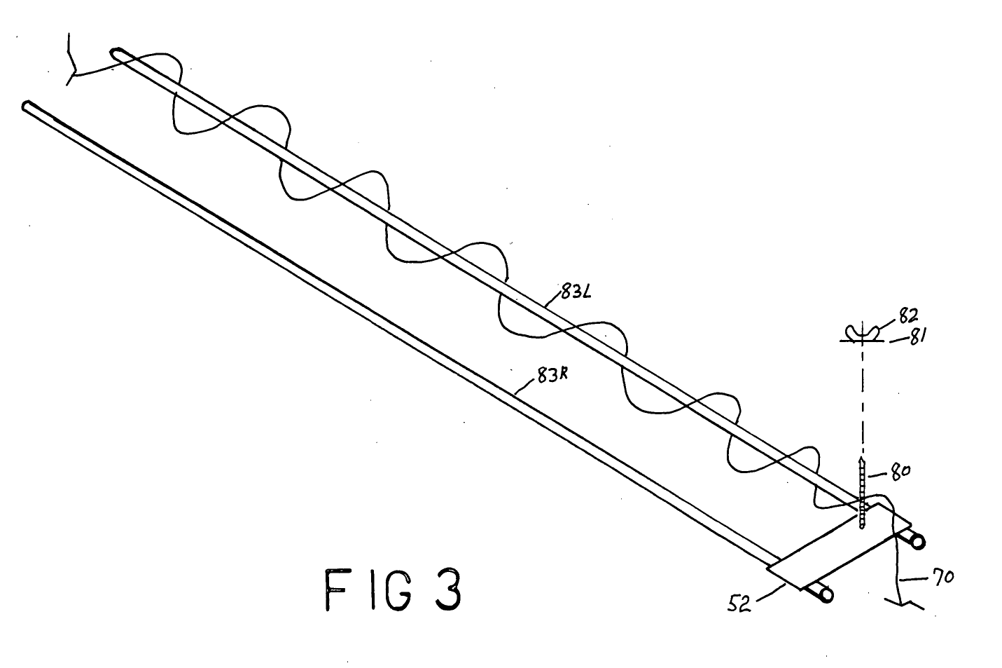

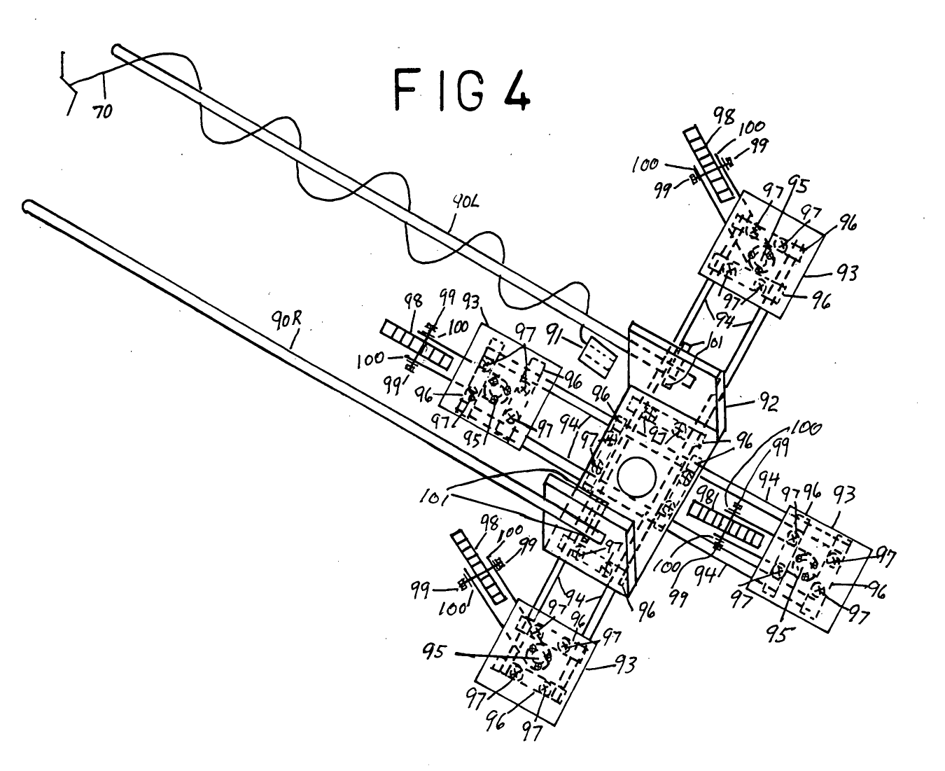

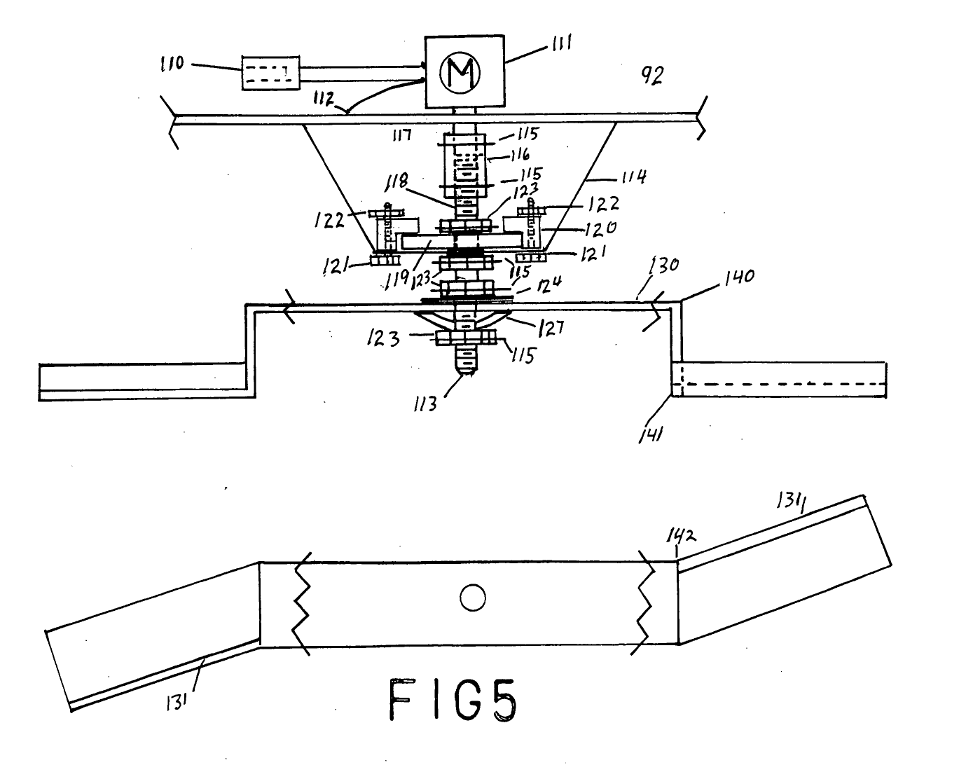

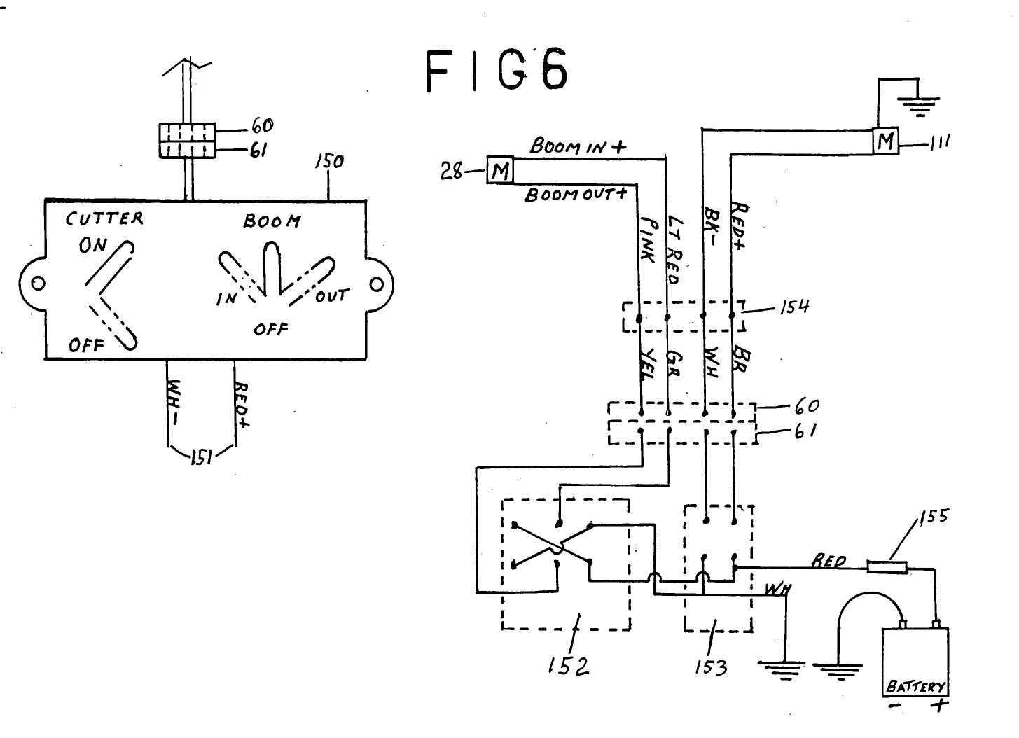

This riding mower attachment is an electric, 12 volt D.C., rotary blade, grass cutter as detailed in FIG. 5, mounted on a hinged motor support as shown in FIG. 4, and rolls on wheels that are swiveled. Also important, the wheel arrangement has wheels in front and behind cutting blade and on each side of the blade. This allows cutting head to ride up and over low obstacles, and to follow the ground. Swivel wheels are essential, as boom is extended and retracted, it continues to cut. Also essential, is a very efficient grass cutting blade. Special shape of this blade, as shown in FIG. 5, provides a slicing action, like a sythe, instead of a straight-on cut. It is much more efficient. Cutting head is flexible to turn, twist and yaw, as ground shape requires. This cutting head is mounted on the end of a three-section, electrically telescoping boom. Various boom lengths are used as required by area to be cut. The entire boom and cutter mounts on the hood of a riding mower type carrier as shown in FIG. 1 and FIG. 2. Cutter head and boom are operated by switches on a dash mounted control box, FIG. 6. Carrier vehicle is not part of this application and is not shown in drawings. The hood of the carrier vehicle is reinforced to carry the weight; and, hood is bolted closed. Reinforcement and hood bolts are not shown in drawings. Boom support mount 63 FIG. 2 is permanently bolted to carrier. Universal ½ inch pipe joints 64 FIG. 2 secures boom section 1, FIG. 2, to carrier. Boom section 2, FIG. 3, telescopes into boom section 1. The last section, boom section 3, FIG. 4, telescopes into boom Section 2, FIG. 3. Boom push rod 31 FIG. 2 is fastened to boom section 2 FIG. 3 by push rod connection bolt 80 FIG. 3. Elevation control ropes 50 and 51 FIG. 2 are snapped into eye bolts on carrier. These eye bolts are not shown on drawings. Control box 150 FIG. 6 is plugged into boom wiring with connectors 60 and 61 FIG. 2. Stated simply, this invention is an electric grass cutter mounted on a three-section electrically telescoping boom, all carried on a motorized carrier. Counter-weights 21 FIG. 2 assist balance of boom.

### ADDITIONAL EMBODIMENTS

This same boom-mounted grass cutter can easily be modified by changing boom mounting 63 FIG. 2 so that boom rotates. With this rotation around carrier vehicle of about 300 degrees, grass cutter will reach many trimming areas easier. This described model is smaller, but with same cutter head and blade FIG. 5. Rotation could be manual or electrical. Electrical rotation is preferred. This would allow entire machine, on it's carrier vehicle, to be transported easier on a trailer to job cites by rotating boom back over carrier seat, or to the rear, and locking it there for transport. This model is under development by me now. It is not shown in the drawings.

### ALTERNATIVE EMBODIMENTS

Many alternatives are possible, and could be used; but, in my opinion are not advisable: such as, 110 volt operation, by use of voltage converters, instead of 12 volt low current D.C. motors. Also use of larger batteries or out-board, add-on batteries in lieu of small mower type battery of carrier vehicle; or, 24 volt D.C. operation instead of 12 volt D.C. There are many choices of materials for manufacture, but a compromise between strength, cost and weight must be made. These alternatives were considered during development.

### OPERATION

Stay clear of sharp blades at all times. First, charge the carrier battery before use about one hour at 6 amps, or until charger dial or indicator shows about 75 percent charged. Use a small 12 volt lawn mower type charger. After charging battery, be sure both control switches 150 FIG. 6 are in off position. Plug boom connector 60 FIG. 6 into control box connector 61 FIG. 6. Be sure cutter motor plug 110 FIG. 5 is plugged into boom-half connector 91 FIG. 4. Place 2 or 3 counter-weights 21 FIG. 2 into counter-weight box 20 FIG. 2. Use boom out-in switch 150 FIG. 6 to fully retract the boom. At this point, boom should be balanced, and with elevation lock 58 FIG. 2 unlocked, boom elevation should be easily hand cranked up and down by 59 FIG. 2. Use more or less counter-weights 21 FIG. 2 to balance boom. This is the only purpose of the weights. In operation, while cutting, the cutter end of the boom rolls on its own wheels and no further balance is needed. Retract boom, lock elevation, and try cutter motor. It should run at full speed smoothly. Turn it off, elevate boom to horizontal, lock elevation and travel to area to be cut. When you are in position for cutting, unlock elevation, extend boom slowly and cutter end will slowly go down until wheels rest on the ground. Use care to not slam cutter into the ground. Position cutter in edge of grass to be cut. Turn cutter on, 150 FIG. 6, put carrier in a slow forward speed and travel forward. Only a good idle engine speed is required. Faster engine speed will not send any more electric charge back into the battery. As you travel, grass will be cut and blown up and away due to propeller up-lift of blade. Adjust boom out-in, or guide carrier, to cut desired area. At end of run, extend boom about two feet and continue cutting in reverse to starting point. Cutter works just as well when it is being boomed out and in as it does when traveling. Use this later method to cut around tall obstacles. Boom will electrically extend from a minimum of 5 feet to a maximum 20 feet. If more reach is required, manually extend boom section 3 to desired length. Boom lengths vary as required for individual yards. Some requirements would be as short as 8 feet overall length; others would be longer. Overall length would be as required.

1. A boom-mounted grass cutting attachment for mounting on a steerable, powered, riding carrier or vehicle. Such carrier is not a part of this application. This attachment is designed to be fastened to the hood of small riding mowers and similar vehicles.

2. Boom of claim 1 has nominal extension from 5 feet to 20 feet and retracts, but is of various overall lengths as use requires.

3. Boom and cutter of claim 1 are electric powered, motor driven.

4. Boom and cutter of claim 1 are controlled by electric toggle switches.

5. Boom of claim 1 can be elevated up or down 45 degrees from horizontal.

6. Boom and cutter of claim 1 are powered from carrier battery.

7. Boom and cutter of claim 1 have a nominal use of 25 amps D.C. current at 12 volts.

8. Grass cutter of claim 1 is for yard or off-road use; not for highway or road use.
